(19) United States
(12) Patent Application Publication
(10) Pub. No.: US 2013/0135843 A1
(43) Pub. Date: May 30, 2013

(54) LIGHT GUIDE PLATE STRUCTURE AND BACKLIGHT MODULE USING THE SAME

(71) Applicants: Chien-Hung CHEN, Hsin-Chu (TW); Ying-Chih Pan, Hsin-Chu (TW)

(72) Inventors: Chien-Hung CHEN, Hsin-Chu (TW); Ying-Chih Pan, Hsin-Chu (TW)

(73) Assignee: Au Optronics Corporation, Hsin-chu (TW)

(21) Appl. No.: 13/534,229

(22) Filed: Jun. 27, 2012

(30) Foreign Application Priority Data
Nov. 30, 2011 (TW) 100144052

(51) Int. Cl. F21V 8/00

(52) U.S. Cl. 362/97.1; 362/343

(57) ABSTRACT

A light guide plate structure is provided. The light guide plate structure includes a plurality of light guide pieces and a plurality of reflectors. Each of the light guide pieces including two inclined surfaces parallel to each other, and the light guide pieces are spliced at their inclined surfaces. The reflectors are disposed between the inclined surfaces. A backlight module using the light guide plate is also provided

### RELATED APPLICATIONS

This application claims priority to Taiwan Application Serial Number 100144052, filed Nov. 30, 2011, which is herein incorporated by reference.

### BACKGROUND

1. Field of Invention

The present invention relates to a backlight module. More particularly, the present invention relates to a direct type backlight module.

2. Description of Related Art

A flat display mainly includes a backlight module, a display panel, and a frame. The backlight module is utilized for providing a light source to enable the display panel to display a normal and uniform image. The backlight module includes plural optical sheets, such as a light guide plate, a diffusion sheet, and a prism sheet for uniformly distributing the light emitted from the light source on the display panel to provide images. The frame includes a bezel and a mold frame for fastening the display panel and the backlight module.

However, recently, electronic apparatuses are developed towards the trend of lightweight and thinness, and flat displays are also designed towards the direction of lightweight and thinness. Hence, even though having the advantages of local dimming function, a direct type backlight module is still hard to meet the requirements of the flat display of lightweight and thinness due to its relatively large thickness.

### SUMMARY

The present invention provides a spliced type light guide plate structure and a backlight module using the same to reduce a thickness of a direct type backlight module.

An aspect of the invention is to provide a light guide plate structure. The light guide plate structure includes a plurality of light guide pieces and a plurality of reflectors. Each of the light guide pieces includes two inclined surfaces parallel to each other, and the light guide pieces are spliced at two adjacent inclined surfaces. The reflectors are disposed between the inclined surfaces. The two inclined surfaces include a light-entering inclined surface and a light-emitting inclined surface, and each of the light guide pieces includes a light-entering surface and a light-emitting surface connecting to the light-entering inclined surface and the light-emitting inclined surface, and the light-entering surface is parallel to the light-emitting surface. An angle between the light-entering inclined surface and the light-entering surface is an acute angle. The angle between the light-entering inclined surface and the light-entering surface is about from 25 degrees to 65 degrees. A cross-sectional profile of each of the light guide pieces is a parallelogram. The reflectors can be disposed on the light-entering inclined surfaces or the light-emitting inclined surfaces respectively.

Another aspect of the invention is to provide a backlight module. The backlight module includes a back plate, a light guide plate structure, and a plurality of light sources. The light guide plate structure is disposed on the back plate. The light guide plate structure includes a plurality of light guide pieces and a plurality of reflectors. Each of the light guide pieces includes a light-entering inclined surface and a light-emitting inclined surface parallel to each other. The light guide pieces are spliced at two adjacent light-entering inclined surface and light-emitting inclined surface. Each of the light guide pieces further includes a light-entering surface and a light-emitting surface which are connected to the light-entering inclined surface and the light-emitting inclined surface, and the light-entering surface is parallel to the light-emitting surface. The reflectors are disposed between the light guide pieces. The light sources are disposed under the light-entering surfaces and close to the light-entering inclined surfaces. An angle between the light-entering inclined surface and the light-entering surface is an acute angle. The angle between the light-entering inclined surface and the light-entering surface is about from 25 degrees to 65 degrees. A cross-sectional profile of each of the light guide pieces is a parallelogram. The reflectors are disposed on the light-entering inclined surfaces or the light-emitting surfaces respectively. The back plate includes a plurality of positioning pins, and each of the light guide pieces includes at least one positioning hole. The position pins are engaged with the positioning holes to fix the light guide pieces on the back plate. The light sources under each of the light guide pieces may have the same or different lightness.

The backlight module uses the light guide plate structure having spliced light guide pieces and reflectors disposed therebetween to reduce the thickness of the light guide pieces. Thus, the thickness of the direct type backlight module can be reduced. Furthermore, the light guide plate structure includes plural spliced light guide pieces, and the light sources are disposed under the light guide pieces for providing local dimming function.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a side view of an embodiment of a light guide plate structure of the invention;

FIG. 2 is a cross-sectional view of an embodiment of a backlight module of the invention; and

FIG. 3 is a partial top view of the backlight module shown in FIG. 2.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In order to enable the direct type backlight module to achieve the requirements of thinness and lightness, the present disclosure provides a direct type backlight module using a spliced type light guide plate structure to reduce the thickness of the direct type backlight module and simplify the process for splicing light guide pieces for improving assembly efficiency.

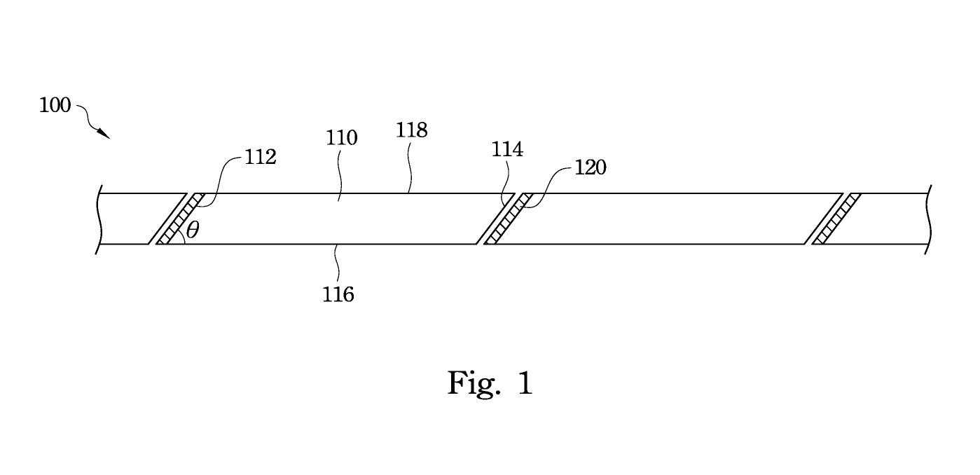

FIG. 1 is a side view of an embodiment of a light guide plate structure 100 of the invention. The light guide plate structure 100 has a plurality of light guide pieces 110 and a plurality of reflectors 120. Each of the light guide pieces 110 has two inclined surfaces parallel to each other, and the light guide pieces 110 are spliced at two adjacent inclined surfaces. The reflectors 120 are disposed between the inclined surfaces.

More particularly, the cross-sectional profile of the light guide piece 110 is similar to a parallelogram. The two inclined surfaces include a light-entering inclined surface 112 and a light-emitting inclined surface 114. The light guide piece 110 further includes a light-entering surface 116 and a light-emitting surface 118 which are connected to the light-entering inclined surface 112 and the light-emitting inclined surface 114. The light-entering surface 116 is parallel to the light-emitting surface 118, and the light-entering inclined surface 112 is parallel to the light-emitting inclined surface 114. An angle θ between the light-entering inclined surface 112 and the light entering surface 116 is an acute angle. The angle θ is about from 25 degrees to 65 degrees. The reflectors 120 can be disposed on the light-entering inclined surfaces 112 or the light-emitting inclined surfaces 114. The reflector 120 can be a reflecting sheet adhered to the light-entering inclined surface 112 or the light-emitting inclined surface 114. Alternatively, the reflector 120 can be a reflecting material applied on the light-entering inclined surface 112 or the light-emitting inclined surface 114.

When the light guide pieces 110 are spliced together, the light-emitting inclined surface 114 of each light guide piece 110 is pressed on the light-entering inclined surface 112 of a next light guide piece 110 so as to form the light guide plate structure 100. The light-entering inclined surfaces 112 are parallel to the light-emitting inclined surfaces 114 respectively, such that the light guide pieces 110 can be firmly assembled. The light-entering surfaces 116 are co-planarly arranged. The light-emitting surfaces 118 are co-planarly arranged.

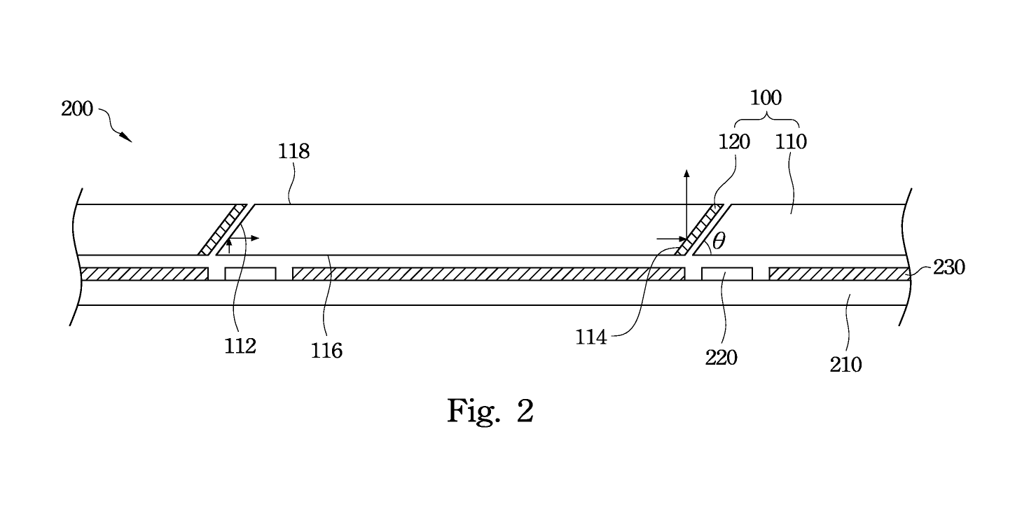

FIG. 2 is a cross-sectional view of an embodiment of a backlight module 200 of the invention. The backlight module 200 includes a back plate 210, the light guide plate structure 100, and a plurality of light sources 220. The light guide plate structure 100 is disposed on the back plate 210. The light guide plate structure 100 has the light guide pieces 110 and the reflectors 120. The cross-sectional profile of the light guide piece 110 is similar to a parallelogram. Each of the light guide pieces 110 includes the light-entering inclined surface 112 and the light-emitting inclined surface 114 which are parallel to each other. The light guide piece 110 includes the light-entering surface 116 and the light-emitting surface 118 which are connected to the light-entering inclined surface 112 and the light-emitting inclined surface 114. The light-entering surface 116 is parallel to the light-emitting surface 118, and the light-entering inclined surface 112 is parallel to the light-emitting inclined surface 114. The angle θ between the light-entering inclined surface 112 and the light entering surface 116 is an acute angle. The angle θ is about from 25 degrees to 65 degrees. The light sources 220 are disposed under the light guide plate structure 100, and the light-entering surfaces 116 face the light sources 220. The light sources 220 are disposed between the light guide plate structure 100 and the back plate 210. The light sources 220 are disposed close to the light-entering inclined surface 112.

The light sources 220 are disposed under the light guide plate structure 100. Therefore, the backlight module 200 can be regarded as a direct type backlight module. However, the light guide plate structure 100 is formed from splicing plural light guide pieces 110, and the reflectors 120 are disposed between the light guide pieces 110, such that the thickness of the light guide plate structure 100 can be reduced, and the thickness of the backlight module 200 can be also reduced. Detail thereof is described as follows.

The light emitted from the light source 220 enters the light guide piece 110 via the light-entering surface 116, and then is reflected by the reflector 120 because of the design of the acute angle θ between the light-entering inclined surface 112 and the light entering surface 116. The light reflected by the reflector 120 is further reflected within the light guide piece 110 and transmitted toward the light-emitting inclined surface 114. The light-emitting surface 118 may include microstructures for destroying the total reflection within the light guide piece 110, such that the light can be emitted from the light-emitting surface 118. The reflector 120 can be disposed on the light-entering inclined surface 112 or light-emitting inclined surface 114 adjacent thereto. The light is reflected within the light guide piece 110 and transmitted toward the light-emitting inclined surface 114, thereby reducing the thickness of the light guide piece 110.

The light emitted from the light sources 220 under each of the light guide pieces 110 may enter the corresponding light guide piece 110 respectively, and then the light is reflected within the corresponding light guide piece 110 and is emitted from the same light guide piece 110. By such a design, the light emitted from light sources 220 is mainly emitted from the corresponding light guide piece 110, such that the lightness of the light sources 220 under each of the light guide piece 110 can be the same or different, and the lightness of the light emitted from each of the light guide pieces 110 can be the same or different for local dimming or enhancing dynamic contrast. The backlight module 200 may optionally include a reflecting film 230.

The reflecting film 230 is disposed on the back plate 210. The reflecting film 230 is disposed next to the light sources 220. The reflecting film 230 is disposed between the back plate 210 and the light guide pieces 110 for reflecting the light toward the light emitting surfaces 118. Alternatively, the back plate 210 can have reflecting function, and thus the reflecting film 230 can be omitted. The width of each light guide piece 110 (e.g. the distance between the light-entering inclined surface 112 and the light-emitting inclined surface 114) is about from 3 cm to 10 cm.

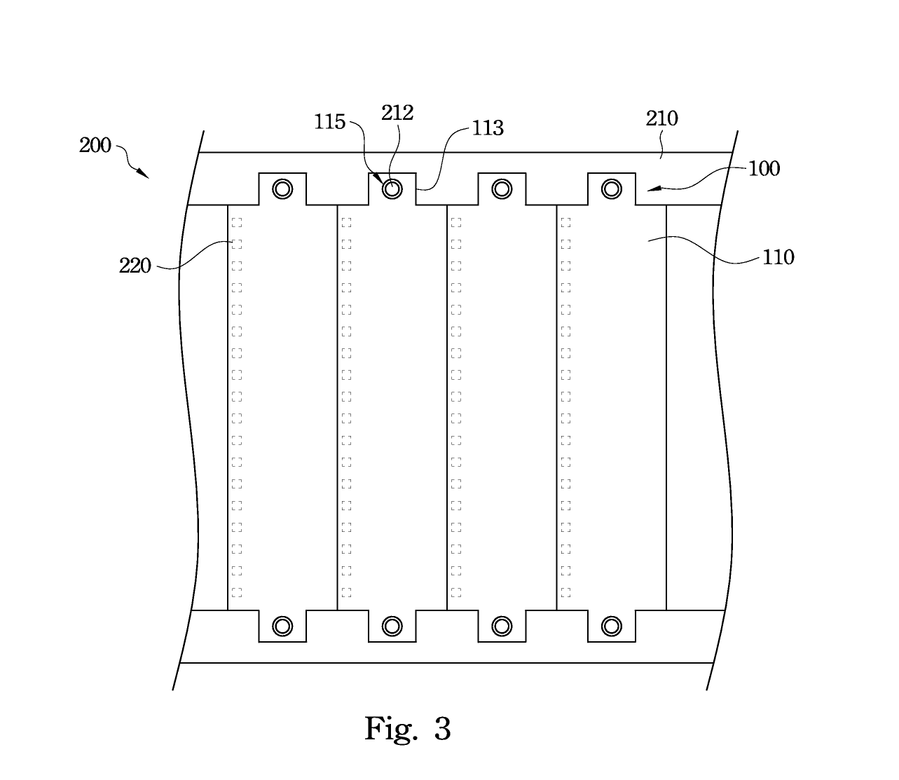

FIG. 3 is a partial top view of the backlight module in FIG. 2. The backlight module includes the backlight sheet 210, the light guide plate structure 100, and the light sources 220. The light sources 220 are linearly disposed under the light guide pieced 110. In order to position the light guide plate structure 100 on the back plate 210, the back plate 210 includes a plurality of positioning pins 212, and each of the light guide pieces 110 includes ay least one positioning hole 115. The position holes 115 are engaged with the positioning pins 212 respectively for fixing the light guide pieces 110 on the back plate 210. Each of the light guide pieces 110 may have at least one protrusion 113, and the positioning hole 115 is disposed on the protrusion 113. The back plate 210 can be made of plastic or metal. The positioning pins 212 can be formed on the back plate 210 by a punching process, an injection molding process, or a riveting process.

The backlight module uses the light guide plate structure having spliced light guide pieces and reflectors disposed therebetween to reduce the thickness of the light guide pieces. Thus, the thickness of the direct type backlight to module can be reduced. Furthermore, the light guide plate structure includes plural spliced light guide pieces, and the light sources are disposed under the light guide pieces 110, thereby providing local dimming function.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light guide plate structure, comprising:
a plurality of light guide pieces, each of the light guide pieces comprising two inclined surfaces parallel to each other, wherein the light guide pieces are spliced at two adjacent inclined surfaces; and
a plurality of reflectors each of which is disposed between two adjacent inclined surfaces.

2. The light guide plate structure of claim 1, wherein the two inclined surfaces comprise a light-entering inclined surface and a light-emitting inclined surface, and each of the light guide pieces comprises a light-entering surface and a light-emitting surface which are connected to the light-entering inclined surface and the light-emitting inclined surface, and the light-entering surface is parallel to the light-emitting surface.

3. The light guide plate structure of claim 2, wherein an angle between the light-entering inclined surface and the light-entering surface is an acute angle.

4. The light guide plate structure of claim 3, wherein the angle between the light-entering inclined surface and the light-entering surface is substantially from 25 degrees to 65 degrees.

5. The light guide plate structure of claim 2, wherein a cross-sectional profile of each of the light guide pieces is a parallelogram.

6. The light guide plate structure of claim 2, wherein the reflectors are disposed on the light-entering inclined surfaces respectively.

7. The light guide plate structure of claim 2, wherein the reflectors are disposed on the light-emitting inclined surfaces respectively.

8. A backlight module, comprising:
a back plate;
a light guide plate structure disposed on the back plate, the light guide plate structure comprising:
a plurality of light guide pieces, each of the light guide pieces comprising a light-entering inclined surface and a light-emitting inclined surface parallel to each other, wherein the light guide pieces are spliced at two adjacent light-entering inclined surface and light-emitting inclined surface, each of the light guide pieces further comprising a light-entering surface and a light-emitting surface which are connected to the light-entering inclined surface and the light-emitting inclined surface, and the light-entering surface is parallel to the light-emitting surface; and
a plurality of reflectors disposed between the light guide pieces; and
a plurality of light sources which are disposed under the light-entering surfaces and close to the light-entering inclined surfaces.

9. The backlight module of claim 8, wherein an angle between the light-entering inclined surface and the light-entering surface is an acute angle.

10. The backlight module of claim 9, wherein the angle between the light-entering inclined surface and the light-entering surface is substantially from 25 degrees to 65 degrees.

11. The backlight module of claim 8, wherein a cross-sectional profile of each of the light guide pieces is a parallelogram.

12. The backlight module of claim 8, wherein the reflectors are disposed on the light-entering inclined surfaces respectively.

13. The backlight module of claim 8, wherein the reflectors are disposed on the light-emitting inclined surfaces respectively.

14. The backlight module of claim 8, wherein the back plate comprises a plurality of positioning pins, and each of the light guide pieces comprises at least one positioning hole, and the positioning pins are engaged with the positioning holes to fix the light guide pieces on the back plate.

15. The backlight module of claim 8, wherein the light sources under each of the light guide pieces have the same lightness.

16. The backlight module of claim 8, wherein the light sources under each of the light guide pieces have different lightness.
